(19) United States
(12) Patent Application Publication
(10) Pub. No.: US 2010/0180430 A1
(43) Pub. Date: Jul. 22, 2010

(54) Spiral Inductors

(75) Inventor: Henry Roskos, Los Gatos, CA (US)

Correspondence Address: FISH & ASSOCIATES, PC;ROBERT D. FISH, 2603 Main Street, Suite 1000, Irvine, CA, 92614-6232, US

(73) Assignee: MVM TECHNOLOGIES, INC., San Clemente, CA (US)

(21) Appl. No.: 12/691,936

(22) Filed: Jan. 22, 2010

Related U.S. Application Data
(60) Provisional application No. 61/146,427, filed on Jan. 22, 2009.

(51) Int. Cl. H01F 41/04

(52) U.S. Cl. 29/602.1

(57) ABSTRACT

Methods of producing a solid state air core spiral inductor are presented. A spiral coil can be deposited on a substrate. One or more solder dams can be positioned on the coil where the dams comprise a well into which solder bumps can be attached to the coil. Material covering the coil or between the gaps the inductor's coil can be removed yielding an air core. Contemplated inductors can include one or more tap points.

This application claims the benefit of priority from U.S. provisional application having Ser. No. 61/146,427 filed on Jan. 22, 2009. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is integrated circuit technologies.

### BACKGROUND

Solid state inductors are often difficult to manufacture and can require a “cross over” structure. It has yet to be appreciated that solid state inductors can be produced having increased trace thicknesses and an air core that result in higher inductance and smaller geometries. For example, gaps between the inductor's spiral coil can be free of material (e.g., a passivation material). Spiral inductors lacking undesirable material in gaps of the coil have greater inductance and greater Q-values allowing for inductors having smaller geometries. Smaller geometries provide for reduced footprint (e.g., higher circuit density) and reduced parasitic resistance or parasitic capacitance.

Thus there is still a considerable need for solid state inductors.

### SUMMARY OF THE INVENTION

The inventive subject matter provides apparatus, systems and methods in which a solid state spiral inductor can be formed with an air core. One aspect of the inventive subject matter includes a method for producing a solid state inductor. For example, one can deposit an insulating layer on a substrate. A metal adhesion layer and a seed layer can then be placed on top of the insulating layer, where the seed layer provides a foundation for creating the inductor's coil. A spiral inductor mask of photoresist can be placed on the seed layer where the mask exposes a spiral trace on the seed layer. The exposed spiral trace allows the coil to form on the seed layer. Trace material can be placed within the exposed trace to increase the thickness of the coil, possibly through electroplating. After a desired thickness has been reached, preferably restricting trace material from forming on top of the photoresist inductor mask, the inductor mask can be removed. A solder bump dam layer, preferably comprising a non-wetting material, can then be deposited. A dam mask can be defined where the mask has one or more solder dams placed at dam locations along the coil. Unwanted portions of the dam layer can be removed, leaving behind solder bump dams at the desired dam locations. The dams have walls comprise the dam layer material and form a well where the trace material is exposed at the bottom of the well. Solder bumps can then be attached to the coil within the dams. In some embodiments, solder bumps are placed within dams at dam locations at ends of the spiral trace. It is also contemplated that solder bumps can be placed within dams at many dam locations along the coil to provide for multiple taps. A multiple tap inductor can be configured to have a variable inductance or Q-value.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a top view of a schematic of a spiral inductor.

FIG. 2 is a side view of a schematic of a conventional spiral inductor having material disposed in gaps of the coil.

FIG. 3 is a side view schematic spiral inductor having an air core.

FIG. 4 is a top view of a schematic of a spiral inductor having multiple taps.

FIG. 5 is a possible method for providing a solid state inductor.

### DETAILED DESCRIPTION

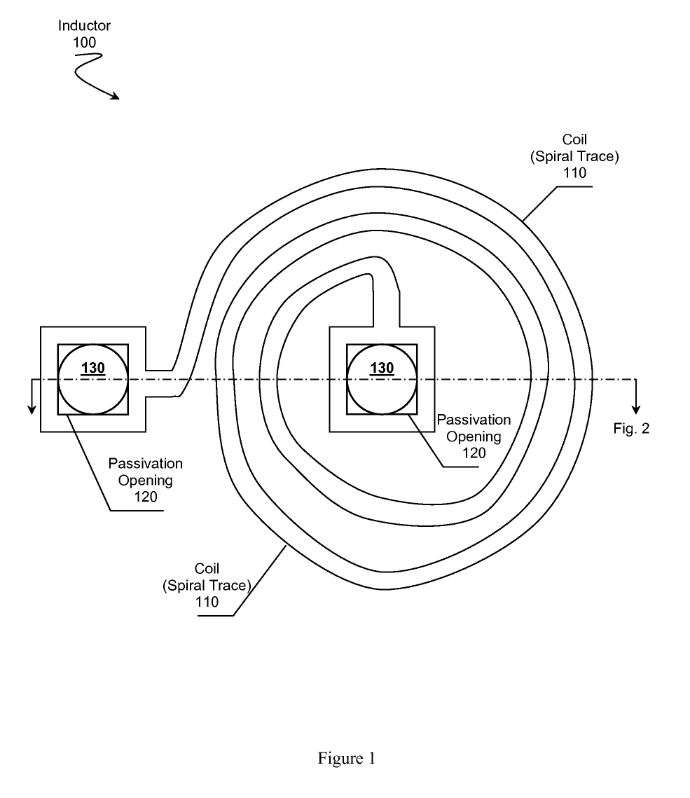

FIG. 1 presents a top view of a contemplated spiral inductor 100. Inductor 100 can comprise coil 110 having a first end and a second end where solder bumps 130 are placed within passivation openings 120. Inductor 100 can be formed on a substrate (e.g., silicon, quarts, etc.).

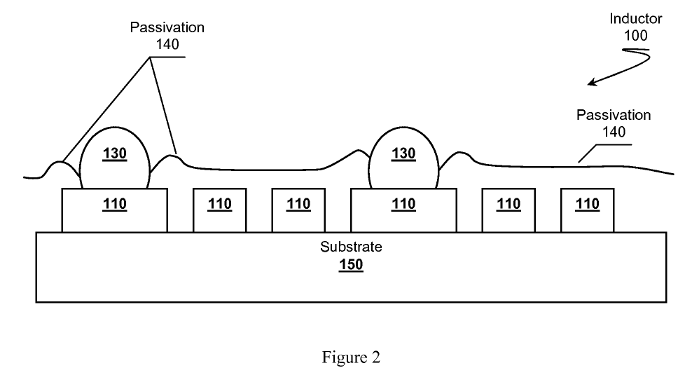

FIG. 2 presents a side view of a typical spiral inductor 100 from FIG. 1 with conventional passivation layer 140. Passivation layer 140 has been used to form solder bump dams at the end of spiral coil 110, where solder bumps 130 are formed. Passivation layer 140 material fills the gaps of coil 110, thus reducing the inductance and the Q-value of spiral inductor 100.

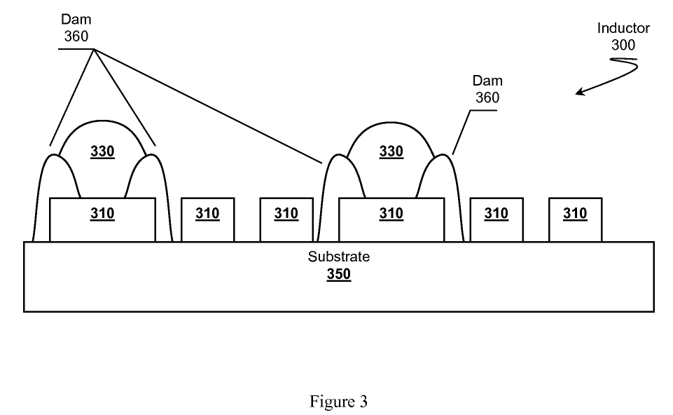

In FIG. 3, spiral inductor 300 lacks material in gaps of inductor coil 310 and is considered to have an air core. Rather than leaving a full passivation layer over coil 310 to form solder bump dams 360, dams 360 are formed only at dam locations where solder bump 330 are to be placed. Dams 360 have material forming well walls and have a bottom where material of coil 310 remains exposed. In the example shown, solder bumps 330 are placed at ends of spiral coil 310. One should also appreciate that solder bump dams 360 could be placed at other locations along coil 310 possibly intermediary between the ends of coil 310.

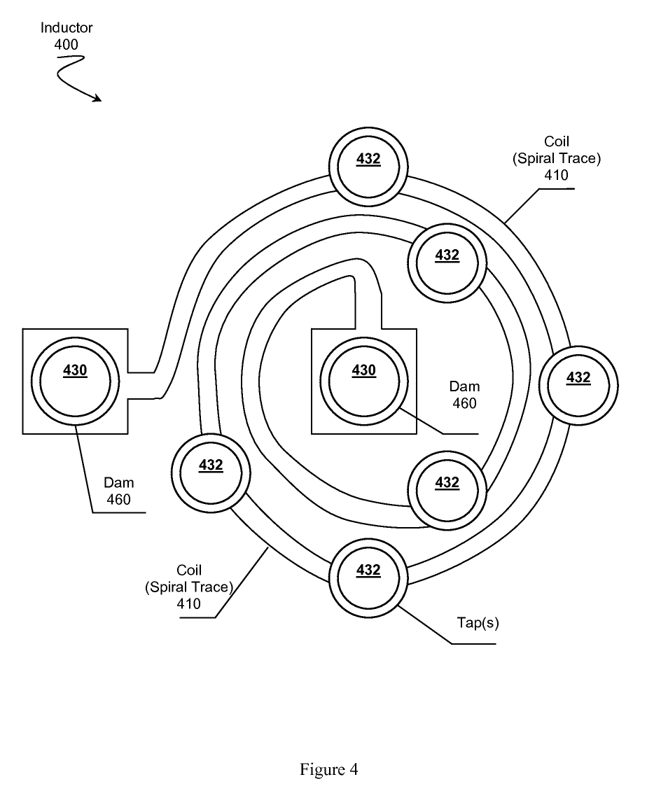

FIG. 4 presents a top view of a multi-tap spiral inductor 400 where solder bumps 432 have been attached in dams at dam locations along coil 410. Such a configuration is considered advantageous to provide a solid state inductor having a tunable inductance or Q-value. Bumps 432 represents a plurality of solder bump taps attached within dams at one or more of the dam locations along coil 410.

Contemplated spiral inductors are preferably formed via a process using a non-wetting (e.g., non-solderable) metal as solder bump dams. Contemplated methods can include two masking operations, three metal deposition operations, and one plating cycle. No passivation operation is required. Preferably a non-conducting substrate can be used to maximize electrical properties of the inductor. For example, the substrate can include quartz or Kapton®.

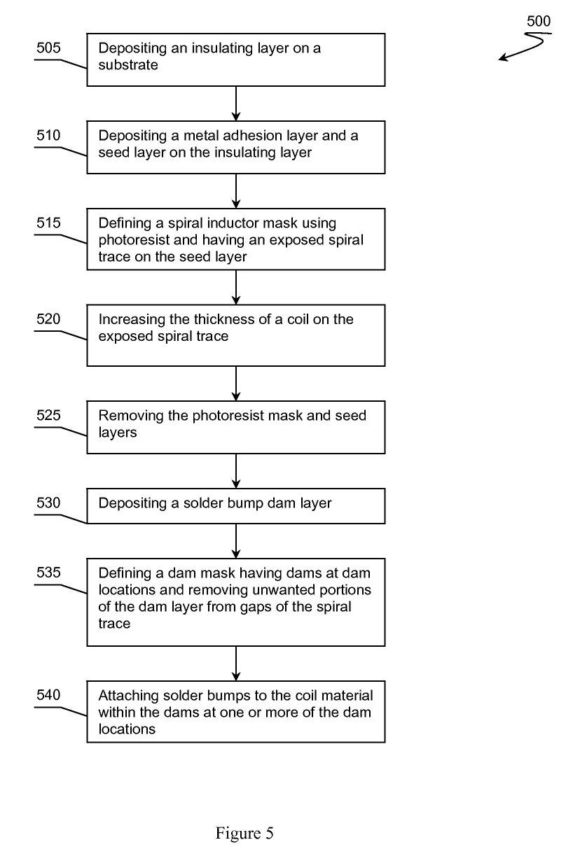

FIG. 5 presents a possible method 500 for producing a solid state inductor having an air core on a substrate (e.g., silicon, quartz, Kapton, etc.).

Step 505 can include depositing an insulating layer on the substrate. The insulator layer provides electrical isolation between the solid state inductor and the substrate. Example materials that can be used for the insulating layer include oxides, nitrides, Spin-on-Glass (SOG), or other materials. For example, depositing the insulating layer can include growing a thermal oxide. The insulating layer typically is deposited to have a thickness of about 4 KÅ to about 8 KÅ.

Step 510 can include depositing a metal adhesion and a seed layer on the insulating layer. In some embodiments, the metal adhesion layer can include Titanium-Tungsten (TiW), which functions as a promoter between the inductor's coil and the insulating layer. Preferably the seed layer comprises Copper (Cu) representing the foundation for the inductor's coil and will be built upon to increase the thickness of the coil during a subsequent plating operation. In embodiments employing Cu, plating is desirable to ensure the Cu traces has sufficient thickness to provide desired electrical properties (e.g., inductance, Q-value, etc.) as traditional deposition methods fail to achieve desired thicknesses.

The TiW adhesion layer is preferably thin, with a thickness of about 250 Å. The Cu seed layer can also be relatively thin, with a thickness of about 1.0 KÅ.

Step 515 preferably includes defining a spiral inductor mask using photoresist, where the mask exposes the seed layer via a defined spiral trace. The exposed spiral traces defines the geometry of the inductor's coil. Preferably the photoresist is of sufficient thickness to keep plated trace material (e.g., Cu) within the exposed spiral trace and to restrict plated trace material from growing on top of the photoresist mask. The mask of the trace can utilize the AZ® 9200 photo resist process. Preferably the depth of the mask is on the order of 20.0 μm.

Step 520 includes increasing the thickness of the coil within the photoresist mask spiral trace. The thickness can be increased by electroplating trace material (e.g., Cu) in the exposed trace, preferably to a thickness of about 20.0 μm. Plating is considered to be advantageous because plating allows for achieving thickness on the order of tens of μm where other traditional techniques do not. The coil preferably comprises Cu for low resistance and affinity for soldering.

Step 525 can include removing the photoresist mask and seed layers. The photoresist can be removed using conventional techniques. Once the photoresist mask has been removed, the seed layer and coil remain. After exposing the seed layer, regions of the seed layer that have not

Step 530 includes depositing a solder bump dam layer, preferable comprising a non-wetting material. The solder bump dam layer aids in preventing solder bump material from wicking up the inductor's coil material (e.g., Cu). Contemplated solder bump dam material can include a conducting material (e.g., Aluminum (Al)) or an insulator material (e.g., SiOx, nitrides, etc.). The solder bump dam layer preferably comprises Al deposited with a thickness of about 2 μm.

Step 535 includes defining a dam mask, which masks off dams at locations on the dam layer. Solder bumps will be attached to the coil at one or more of the dam locations. Photoresist, or other suitable material, can be used to mask off unwanted areas of the solder bump dam layer. The solder bump dam regions can be defined using photoresist, typically having a thickness of about 2.0 to 3.0 μm. Once the regions have been defined, exposed solder bump dam layer material (e.g., Al) can be etched. Step 535 can also include removing unwanted portions of the dam layer material from the gaps of the inductor's spiral trace.

It is also contemplated that one could remove the photoresist layer from step 525 at this point, thus exposing the seed layer. The seed layer can also be removed before attaching solder bumps.

Step 540 can include attaching solder bumps to the coil material within dams located the dam locations defined in step 535. In some embodiments, the solder bumps are only attached at the ends of the inductor's spiral trace. In other embodiments, the solder bumps can be attached at dam locations along the inductor's solder trace intermediary between the ends to provide multiple taps for the inductor.

Thus, specific compositions and methods of the inventive subject matter have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A method of producing a solid state inductor having an air core, the method comprising
depositing an insulating layer on a substrate;
depositing a metal adhesion and seed layer on the insulating layer;
defining a spiral inductor mask using photoresist having an exposed spiral trace on the seed layers;
increasing a thickness of a coil within the spiral trace;
removing the photoresist and seed layers;
depositing a solder bump dam layer;
defining a dam mask having dam locations where solder dams are to be positioned, and removing unwanted portions of the dam layer from gaps of the coil; and
attaching solder bumps within dams at one or more of the dam locations.

2. The method of claim 1, further comprising restricting coil material from forming on top of the photoresist spiral inductor mask.

3. The method of claim 1, wherein the step of attaching solder bumps includes placing a first solder bump at a first dam location at a first end of the coil, and placing a second solder bump at a second dam location at a second end of the coil.

4. The method of claim 3, further comprising attaching a plurality of solder bump taps at one or more of the dam locations along the coil and intermediary to the first and the second ends.

5. The method of claim 1, wherein the solder bump dam layer comprises a non-wetting metal.
